(19) United States
(12) Patent Application Publication
(10) Pub. No.: US 2008/0108009 A1
(43) Pub. Date: May 8, 2008

(54) Obturation device, material and methodolgy

(75) Inventor: Jimmie Kert, Monaco (DK)

Correspondence Address: Crockett & Crockett, Suite 400, 24012 Calle De La Plata, Laguna Hills, CA, 92653, US

(73) Assignee: CMS Dental ApS

(21) Appl. No.: 11/592,673

(22) Filed: Nov. 3, 2006

(51) Int. Cl. A61C 5/02; A61C 19/00; A61C 3/00

(52) U.S. Cl. 433/29; 433/25; 433/224

(57) ABSTRACT

A body cavity obturator having bismuth particles dispersed therein. Bismuth is dispersed throughout the plastic core or shaft, and/or throughout a filler material disposed thereon to produce a plastic article that presents a clearly defined x-ray image similar to that of a steel implementation thereof.

### BACKGROUND

The present disclosure relates generally to obturation devices, materials and methodologies; and, more particularly relates to radio opaque plastic compositions, and articles made from radio opaque plastic compositions, particularly as these may be used in obturation or as obturators in, for one example, an endodontically-prepared root canal of a tooth.

Metals have often been used in medical applications as implants or obturators, such metals providing desirable qualities in strength and x-ray image contrast, inter alia. However, it has further been found that many polymer plastics have inherent characteristics which can make them desirable for use in many medical applications such as in or as tooth and/or bone implants, perhaps more desirable in some circumstances than metals. Unfortunately, when many such implanted plastic articles are subjected to x-rays the resulting image thereof is often not sufficiently well detectable in the x-ray image. Thus, it may become difficult to verify that an obturation process has been carried out successfully, for example, it may be difficult to determine whether a root canal has been completely filled.

In various prior approaches toward potential solutions to such a problem it has been known to mix metals or other materials with or into the plastic materials to produce a composite material that when x-rayed produces an x-ray picture that provides a more desirable image contrast for the obturation material relative to the body. Nevertheless, mixing polymer plastics with metals or other previously tested radio opaque compounds has often led to a weakening of the plastic. In some cases this can be tolerated but in other circumstances, such a weakening of the plastic will not acceptable. The intended use in a root canal procedure requires strength due to a full insertion of the tooth implant into the bottom of the root canal without breakage of the implant.

Another difficulty encountered by prior attempts to improve the radio opacity of polymer plastics through the addition of radio opaque materials to the plastics has been a negative effect on or resulting from the mixing and preparation process. For example, heating a composition of a plastic and a radio opaque additive to the melting temperature of the plastic so that one can mold the composition into a homogeneous product may result in an unacceptable oxidation of the added radio opaque materials. Accordingly, when mixing radio opaque materials into polymer plastics one must prevent the molding process of the plastic and the radio opaque materials from interfering with and in many cases, destroying each other, functionally or otherwise.

Another complication with past efforts at the use of plastic materials in lieu of metals in medical applications has been that even when additives have been provided to the plastic to make the plastic radio opaque, the radio opacity of the resulting material may not be of a sufficient degree for the particular application. For example, in one implementation as described in U.S. Pat. No. 4,758,156, a cone of gutta-percha, a natural latex produced from the sap of gutta-percha trees, is used as an exterior portion of a composite tooth implant, the implant typically also including an interior elongated shaft of metal or a plastic material. The composite insert is then inserted into a root canal of a tooth to form a filling for the tooth. A resulting x-ray image of the tooth with the filling comprising the combination of gutta-percha and interior elongated shaft appears as two distinct materials in the x-ray image of the tooth. Although two materials are present it may be desirable to have the x-ray image of the two distinct materials appear as a single item in an x-ray image in such applications.

Moreover, this desideratum to provide for the two materials to appear as one when x-rayed would in many instances continue with one or more of the other introduced desiderata of preventing the weakening of the implant by the addition of radio opaque filler materials to the implant, and/or of preventing the reduction of operability of the additive by the mixing process. Thus a person may be faced with the simultaneous tasks of making a sufficiently strong implant and also having two different filler materials that when x-rayed produce a single x-ray image without an interface area between the two materials showing up as a void or cavity in the obturated region, e.g., within a root canal processed tooth.

### SUMMARY

Briefly, in one implementation a radio opaque plastic composition is used together with a discrete filler material as an obturator. When a root canal is filled with the radio opaque plastic composition shaft and a filler material and then subjected to x-ray examination, it produces a photo-shadowgraph image wherein the outline of the shaft can be clearly recognized. More specifically, presently described is a discovery of a radio opaque material that can be easily molded with a thermoplastic such as styrene-acrylonitrile copolymer to produce a radio opaque plastic composition. It has been found that the composition, when molded into a tooth implant, produces a solid dental filler material such that when encapsulated with a gutta-percha filler material and inserted into a root canal to form a tooth filler and then subjected to x-rays, produces a photo-shadowgraph with a high contrast.

The present invention solves the problem of mixing radio opaque materials into certain polymer plastics to produce a molded plastic product that is radio opaque so that when x-rayed, the presence of the molded plastic product appears on an x-ray picture of the molded plastic product.

Moreover, the intended use in a root canal procedure requires strength due to the insertion of the composite tooth implant, a gutta-percha filler material and a core shaft, into the bottom of the root canal without breaking the tool.

The invention also includes the discovery of a radio opaque material that can be easily molded with a thermoplastic, such as gutta percha filler material, to produce a radio opaque flowable plastic composition. It has been found that the composition flowable dental filler material, when enforced with a shaft and inserted into a root canal to form a tooth filler and then subjected to x-rays, produces a photo-shadowgraph with a high contrast.

The present invention involves a discovery that the combination of selected amounts of bismuth with a thermoplastic polymer provides a radio opaque article. In addition it has been found that the combination of bismuth with a thermoplastic polymer filler material mixture also can be used to mold a body implant that is detectable by x-rays. It also has been discovered that the use of the present composition in tooth implants for insertion into a root canal as a permanent implant is sufficiently strong to use to force gutta-percha filler material or gutta-percha like material and the tooth implant into a root canal.

The present invention involves another discovery that the inclusion of selected amounts of bismuth in the gutta percha composition improves the radio opacity of a gutta percha composite material. Thus, when used in a root canal obturator, the gutta-percha filler material may appear as a single uniform image on an x-ray image of a filled tooth.

### BRIEF DESCRIPTION OF THE DRAWINGS

In the following detailed portion of the present description, the invention will be explained in more detail with reference to the exemplar implementations shown in the drawings, in which:

FIG. 1 is a sectional view of an obturator having a composition according hereto;

FIG. 2, which includes and is defined by sub-FIGS. 2a, 2b and 2c, illustrates an obturating process for obturation of an extirpated root canal by use of an endodontic obturator according hereto; and

FIG. 3 is an x-ray shadowgraph of an endodontic obturator according hereto, and a conventional endodontic obturator.

### DETAILED DESCRIPTION

Disclosed here is an obturator, such as a root canal obturator, having bismuth particles dispersed therein. Bismuth is dispersed throughout the plastic core or shaft, and/or throughout a filler material disposed thereon to produce a plastic article that presents a clearly defined x-ray image similar to that of a steel implementation thereof. In a root canal obturator, this may then provide a solid tooth implant covered with a flowable gutta-percha filler material for insertion into the root canal of a tooth. Some implementations may involve a mixture for the plastic shaft including approximately 55% by weight styrene-acrylonitrile copolymer and approximately 45% by weight bismuth particles. The flowable gutta-percha filler material may also having bismuth particles dispersed therein, in an amount of between 5% and 15%.

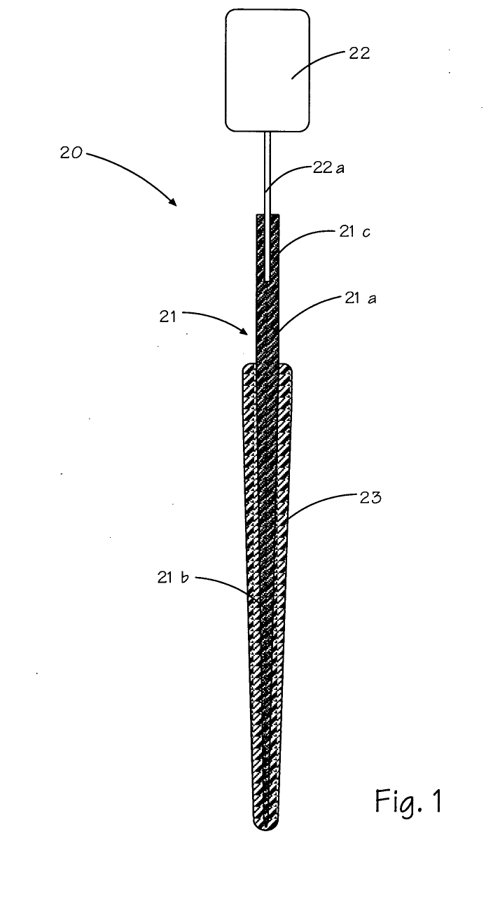

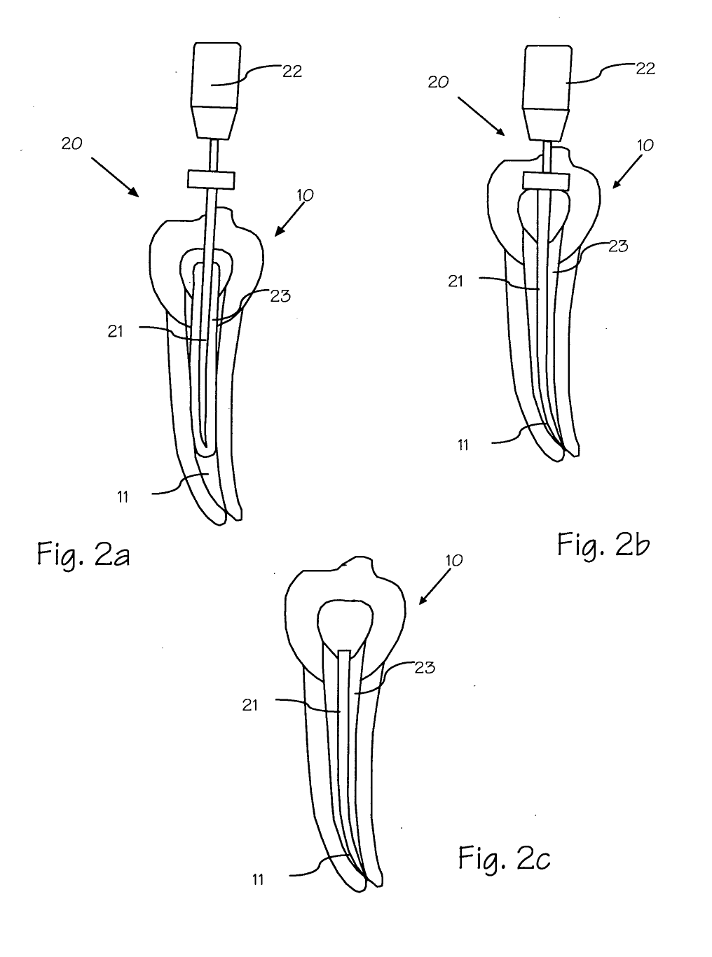

Referring to FIG. 1, there is shown a first implementation of an obturator, here, an endodontic obturator, which is generally denoted using the reference numeral 20. The obturator 20 has an elongated shaft 21 with a distal portion 21b and a proximal portion 21a with a handle portion 21c. The distal portion 21b of the shaft 21 may, as shown, have at least a part being conical or tapered toward the distal end. A handle 22 is shown connected to the handle portion 21c. The handle 22 may be releasably connected to the handle portion 21c, as shown in FIG. 1 by an insertion rod 22a. The handle 22 can be made for example from some suitable plastic material and the insertion rod 22a may be made for example from a carbon steel. The shaft 21 is made in many implementations according hereto of a plastic polymer material that is substantially rigid or stiff, yet sufficiently soft, so as to make it possible to remove the insertion rod 22a from the shaft portion 21c when the shaft 21 has been placed in its final position in a body tissue, e.g., a root canal of a tooth (not shown in FIG. 1, but see FIG. 2 as described further below). The shaft of such a tooth implant may be made of a metal or a substantially rigid plastic so as to have sufficient strength and flexibility to permit a dentist to push the elongated shaft of the tooth implant all the way into a root canal, to the bottom thereof.

As further shown in FIG. 1, a layer of a flowable filler material 23 is coated about at least part of the tapered distal portion 21b of the shaft. The layer of filler material 23 extends from the tapered distal portion 21b to the proximal portion 21a of the shaft. As introduced in U.S. Pat. No. 4,758,156, a filler material 23 may be applied to a shaft 21 for filling an endodontically prepared root canal. Such a tooth implant having an elongated severable, somewhat conical shaft 21 may be coated with a corresponding cone or substantially conical shape of a filler material 23. The filler material may typically be or include gutta-percha, an inelastic natural latex material. The elongated shaft may in one sense act as a carrier for inserting the flowable filler material into the body cavity to be obturated, e.g., into the root canal and to the root apex in a root canal procedure.

To insert the obturator/tooth implant 20 with the gutta-percha filler material 23 into a root canal or like cavity to be filled, the gutta-percha filler material 23 may first be heated or otherwise processed to make it flowable (although it may be that the flowable filler material need no pre-processing to be flowable). Flowable describes the inelastic characteristic of the filler material or gutta-percha to flow into, fill and form fit within an aperture or hole such as that formed during a root canal procedure. The filler material would then fill the entire space within the cavity, wall-to-wall, leaving very little or no air space therewithin. The substantially stiff yet resilient proximal end of the shaft 21 is used to push both the flowable filler material/gutta-percha and the distal end of the shaft into the root canal. Once the gutta-percha and the elongated severable distal end of the shaft compactly fill the voids in the root canal, the user may twist the handle of the tool 20 to break off the severable proximal end of the tool thereby leaving both the severed distal end of the shaft and the gutta-percha as filler material in the root canal.

The filler material, as mentioned, may substantially involve a gutta-percha material; however, one or more additives may be further included to the base resinous material. For example, one or more opacifiers may be added, as for example bismuth and/or barium sulphate. Additional or alternative resins may be employed, as for example a polycaprolactone. Other additives might include medicinals such as zinc oxide (anti-bacterial), antioxidants, e.g., Irganox®, or color or mastication agents, e.g., Renacit®. The melting point of the composite material may be manipulated as for example by including a paraffin wax to lower the overall melting point. In many implementations hereof, the gutta-percha may be present within the range of 25% by weight to 40% by weight, and may typically be present in an amount of approximately 30% by weight (raw) gutta-percha. The opacifier or opacifiers may include bismuth in an amount between about 5% by weight and about 15% by weight. In some implementations, the bismuth may be approximately 8% by weight. Another opacifier of barium sulphate may be included in a range of 15 by weight to 35% by weight, and may more typically be approximately 25% by weight barium sulphate. Another resinous material of polycaprolactone may be included in a range of 5% by weight to 40% by weight, more typically approximately 7% by weight polycaprolactone, type P767. Other additives may include approximately 10% by weight zinc oxide, approximately 10% by weight titanium dioxide, approximately 8% by weight paraffin wax, and approximately 2% antioxidants, pigments and other additives. An exemplar composite material with many of these additives is shown and described in Table A, below.

TABLE A
NY GP test composition
September 2006

| Ingredient | Amount in % | Effect |
|---|---|---|
| Raw gutta-percha | 29.7 | Resin |
| Barium sulphate | 25.0 | Filler/radio opacity |
| Zinc oxide | 10.0 | Filler/medical |
| Bismuth | 8.0 | Radio opacity |
| Titanium dioxide | 10.0 | Filler/whitener |
| Polycaprolactone - Tone p767 | 7.0 | Resin |
| Paraffin wax | 8.4 | Lower melting point |
| Irganox | 1.5 | Antioxidant |
| Color | 0.5 | Color |
| Renacit | 0.1 | Mastication agent |
| Total | Approx. 100.0 | |

It should be noted that gutta-percha is a typically naturally occurring inelastic latex produced from the sap of tropical gutta-percha trees (Palaquium). Moreover, various types of polycaprolactone are commercially available from the Dow Chemical Company, Midland Mich., USA, under the product designations “Tone PCL 767 polymer,” “Tone PCL 787 polymer” and “Tone PCL 757 polymer.” Irganox® antioxidants are available from Ciba Specialty Chemicals, Basel Switzerland. Renacitb mastication agents are available from LANXESS AG of Lerverkusen, Germany.

It should be further noted that the filler material described above may be used with metal shafts or with plastic or other shaft materials. In many implementations according hereto, a polymer plastic shaft material will be used. Principally, a polymer plastic of styrene-acrylonitrile (SAN) copolymer may be used. Such a plastic will be sufficiently rigid and strong to provide for strength during the insertion process, yet will be sufficiently pliable or severable to provide for removal of the proximal end after complete insertion. Such a plastic material may also be satisfactorily operable with a filler material such as that described herein above. Other materials having such or similar characteristics could be substituted herein.

Moreover, it may further or alternatively be desirable to enhance the opacity of the shaft. Such a polymer plastic of styrene-acrylonitrile (SAN) copolymer may also be formed with an opacifier such as bismuth particles dispersed therethrough for improving the contrast of the shaft in an x-ray image, particularly when used as a body cavity obturator, e.g., in a root canal procedure. Other additional or alternative opacifiers may be used, as for example barium sulphate. Note that it may be preferable to provide an opacity which is substantially similar to if not indiscernible from that of the filler material. In such cases, it may then be preferable to use similar, if not the same opacifier, in a matched amount to provide the desirable similarity in overall opacity. However, since the shaft material is necessarily different, a different quantity of opacifier may be desired. In some implementations according hereto, the styrene-acrylonitrile copolymer may be present in the range from about 45% to about 65% by weight of the mixture. An opacifier may then be present in a range of from about 35% to about 55% by weight of the mixture, and, may more particularly be about 45% by weight of the material forming said elongated shaft. Bismuth may be selected as an opacifier for the shaft, where the bismuth may range from about 35% to about 55% by weight of the mixture, or where the bismuth may be about 45% by weight of the material forming said elongated shaft. Thus, in an implementation, a mixture for the plastic shaft/core composition may include approximately 55% by weight styrene-acrylonitrile copolymer and approximately 45% by weight bismuth particles. It may further be noted that medical grade materials may be used or even desired here as well as with the filler materials described above.

Various types of Styrene-acrylonitrile (SAN) are commercially available from the Dow Chemical Company, Midland Mich., USA, under the product designations “TYRIL 100”; “TYRIL 880”; “TYRIL 88B”; and “TYRIL 125.”

The insertion of an obturator according to the present invention in an extirpated root canal is illustrated in FIGS. 2a, 2b and 2c. Here, an obturator substantially similar to the obturator 20 of FIG. 1 is used. When the root canal 11 of a tooth 10 has been prepared, see e.g., FIG. 2, particularly sub-FIG. 2a, and the ensuing description thereof; the layer of filler material 23 on the shaft 21 of the obturator device 20 may be heated to a temperature where it is sufficiently soft to adapt itself to the walls of the root canal 11, i.e., to a temperature at which substantially all the filler material 23 is in a partially or substantially melted or plasticized state. At this point, the obturator 20 may then be inserted in the root canal 11, see FIG. 2a, with the tapered or distal end of shaft 21 and the filler material 23 leading. During the insertion, the obturator may be held and moved or manipulated by the handle 22.

More particularly, as shown in FIG. 2a the obturator 20 is partly inserted in the root canal 11 with the flowable filler material 23 in a molten or semi-molten condition during the insertion operation, in which the obturator 20 is moved by means of the handle 22. In FIG. 2b, the obturator 20 is fully inserted and the root canal 11 is filled by the filling material 23. Desirably, the filler material, e.g., the gutta-percha composite mixture, would fill substantially all voids in the canal area, preferably leaving substantially no air pockets. When using the obturator 20 of FIG. 2, after the layer of filler material 23 has been placed in its final position in the root canal 11, and sufficient time has elapsed to allow it to cure or set, the handle 22 can then be removed and the excess part of the shaft 21 is separated, e.g. by cutting the excess part of the shaft 21. In FIG. 2c, the filler material 23 has cured and the handle 22 and the excess part of the shaft 21 have been removed.

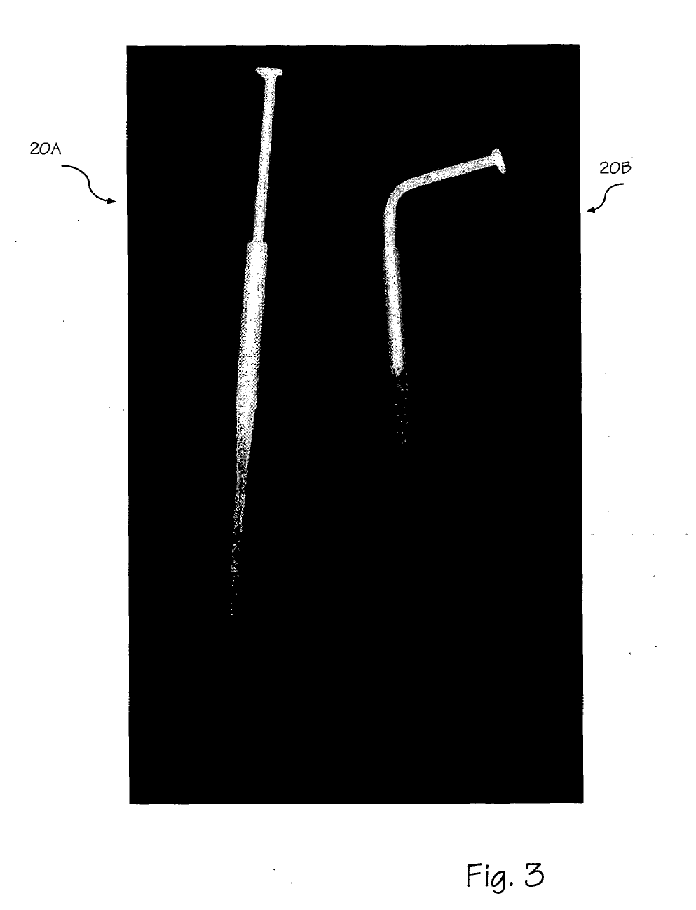

In an x-ray image the obturator according to the present invention has a clear contrast with the surrounding tissue. An example of this is shown by the shadowgraph of the obturator 20A in FIG. 3. Here, a person viewing the x-ray image may clearly distinguish the contour of the obturator, both of the shaft and of the filler material, to verify whether the alteration has been complete. By contrast, the obturator 20B of FIG. 3 has insufficient opacity to x-ray imagery, and it is difficult to distinguish the obturator filler material from the body tissue. Note also that there is little if any distinction between the shaft and the filler material in the exemplar obturator 20A of FIG. 3, both having been mixed with respective amounts of bismuth to provide the desired opacity and x-ray imagery contrast.

Moreover, the present mixes of radio opaque materials into the filler material used to make the tooth implant do not substantially weaken the plastic/polymer of either the filler material or the shaft. It may be that prior attempts with similar mixes of a radio opaque material into a polymer have weakened the composite due to the radio opaque material acting as a spacer and filter within the composition and thereby lessening or weakening the polymeric bonds. Bismuth in powder form as may be used herein does not appear to provide such a weakening, at least not insofar as the tool would not be sufficiently strong for use in the intended manner.

Although the present invention has been described in detail for purpose of illustration, it is understood that such detail is solely for that purpose, and variations can be made therein by those skilled in the art without departing from the scope of the invention.

What is claimed is:

1. An obturator comprising:
an elongated shaft;
a flowable filler material disposed on the elongated shaft;
the elongated shaft being made from a polymer plastic having bismuth particles dispersed there through.

2. The obturator of claim 1, wherein the bismuth ranges from about 35% to about 55% by weight of the shaft.

3. The obturator of claim 1, wherein said bismuth comprises about 45% by weight of the material forming said elongated shaft.

4. The obturator of claim 1, wherein said polymer plastic is styrene-acrylonitrile copolymer.

5. The obturator of claim 4, wherein the bismuth ranges from about 35% to about 55% by weight of the shaft.

6. The obturator of claim 4, wherein the styrene-acrylonitrile copolymer ranges from about 45% to about 65% by weight of the shaft.

7. The obturator of claim 1, wherein said flowable filler material comprises gutta-percha.

8. The obturator of claim 1, wherein said flowable filler material has bismuth particles dispersed there through.

9. The obturator of claim 8, wherein said flowable filler material contains approximately 8% by weight bismuth.

10. The obturator of claim 8, wherein the bismuth content ranges from approximately 5% to approximately 15% by weight of the flowable filler material.

11. The obturator of claim 8, wherein the respective bismuth contents of the elongated shaft and of the flowable filler material cause an x-ray image of said obturator to present by contrast the shape of the obturator to enable a determination of one or both of the shape and boundaries of the obturator.

12. An obturator comprising:
an elongated shaft;
a flowable filler material disposed on said shaft;
the flowable filler material comprising gutta-percha and bismuth particles dispersed there through.

13. The obturator of claim 12, wherein said flowable filler material contains approximately 8% by weight bismuth.

14. The obturator of claim 12, wherein the bismuth content ranges from approximately 5% to approximately 15% by weight of the flowable filler material.

15. The obturator of claim 12, wherein said flowable filler material has barium sulphate particles dispersed there through.

16. The obturator of claim 15, wherein said flowable filler material contains approximately 25% by weight barium sulphate.

17. The obturator of claim 12, wherein said flowable filler material contains polycaprolactone.

18. The obturator of claim 12, wherein said flowable filler material contains approximately 7% by weight polycaprolactone.

19. A method for obturating a body cavity, said method comprising:
providing an obturator having:
an elongated shaft; and,
a flowable filler material disposed on the elongated shaft; the obturator having bismuth dispersed therein, in one or both of the elongated shaft and the flowable filler material; and,
inserting the obturator in the body cavity to be obturated.

20. A method according to claim 19 further including:
obtaining an image of the obturation to ensure an appropriate filling of the body cavity.

21. A method according to claim 19 wherein the obturation is a filling of a root canal of an endodontically prepared tooth.
